(19) United States
(12) Patent Application Publication
(10) Pub. No.: US 2006/0196271 A1
(43) Pub. Date: Sep. 7, 2006

(54) Acoustic array analytical system

(76) Inventors: Bela Jancsik, Philadelphia, PA (US); Gabor Klivenyi, Szeged (HU); Karoly Revesz, Hosszuheteny (HU)

Correspondence Address: Knoble Yoshida & Dunleavy;Eight Penn Center, Suite 1350, 1628 John F Kennedy Boulevard, Philadephia, PA, 19103, US

(21) Appl. No.: 10/533,284

(22) PCT Filed: Oct. 27, 2003
(86) PCT No.: PCT/US03/34068

§ 371 Date: Apr. 21, 2006

Related U.S. Application Data
(60) Provisional application No. 60/421,743, filed on Oct. 28, 2002.

(51) Int. Cl. G01H 13/00; G01N 29/46; G01N 29/26

(52) U.S. Cl. 73/579; 73/641; 73/612

(57) ABSTRACT

A multi-channel acoustic measurement device, which includes a plurality of acoustic detectors (3) and dual temperature control (1, 2). The device employs piezoelectric crystal (21) as the sensing material in the detectors and has an appropriate driving device (40) connected to the detectors for oscillating the piezoelectric crystals. The device may also include a user interface. Also disclosed is a method of measuring in label-free mode at least one property of a plurality of samples in parallel using a plurality of acoustic detectors (3) and dual temperature control (1, 2).

### BACKGROUND OF THE INVENTION

1. Field of the Invention

The invention relates generally to devices for measuring certain physical and chemical properties of materials. More specifically, the invention relates to piezoelectric transducers that can be employed for multiple measurements of physical and chemical properties in parallel.

2. Brief Description of the Prior Art

Acoustic measurement devices have long been examined for use in the measurement of a variety of chemical and physical properties such as viscosity, elasticity, mass and particle size. Such devices have been used, for example, in LAL-endotoxin testing, in fibrinogen determination, to measure protein-binding kinetics, particle size analysis, sensing of bio-films and for viscosity determinations.

Other areas where acoustic measurement devices can be useful include quality control analysis, drug discovery, macromolecular analyses, and clinical chemistry. However, such applications have been difficult to achieve using such acoustic measurement devices for a variety of reasons. For example, quality control apparatus requires multiple sample cells or arrays of cells, programmable temperature controls, qualification controls, suitable signal processing algorithms and/or circuitry, detector cleaning procedures to permit reuse of the device, and adaptation to correlate with standard quality control procedures. Apparatus for drug delivery requires all of the elements of a quality control device, as well as high throughput, in vitro analysis controls, effective database architecture and data analysis facilities. Apparatus for clinical chemistry requires all of the elements of a quality control device, as well as storage of calibration data and control values.

Currently available apparatus suffers from serious drawbacks. First, most currently available devices do not include multiple detectors for handling multiple samples simultaneously. Such devices also lack suitable controllers and data processing capabilities for performing parallel analysis of data from multiple samples. Also, many current devices do not integrate programmable temperature control or sufficient validation and qualification controls to ensure precise, accurate, reproducible and reliable results. Also, current devices require improved sensitivity, accuracy, precision reproducibility and robustness and increased dynamic range in order to be useful for quality control applications.

U.S. Pat. No. 6,006,589 (Rodahl et al.) describes a QCM device and a process for measurement of resonant frequency, changes in resonant frequency, dissipation factor and changes in dissipation factor. This device may be used, for example, for measurement of protein adsorption kinetics. However, the device does not include mult-channel capabilities, programmable temperature control or signal processing capabilities with integrated calculation algorithms.

U.S. Pat. No. 5,487,981 (Nivens et al.) describes a QCM device and method for in-line sensing of the presence of bio-film in pure water systems. The device does not include multi-channel capabilities, programmable temperature control or signal processing capabilities with integrated calculation algorithms. Also, this patent does not describe a way to re-use the detectors and thus appears to require replacement of the sensors after each measurement.

U.S. Pat. No. 5,211,054 (Muramatsu et al.) describes a viscosity measurement system based on QCM. The device has been used for the measurement of endotoxins and fibrinogens. The device does not include multi-channel capabilities, programmable temperature control or signal processing capabilities. Also, this patent does not describe a way to re-use the detectors and thus appears to require replacement of the sensors after each measurement.

U.S. Pat. No. 6,141,625 (Smith et al.) describes a single channel, portable viscometer based on QCM. The device does not include multi-channel capabilities, programmable temperature control or signal processing capabilities with integrated calculation algorithms.

There remains a need for reliable, sensitive measuring devices based on QCM that provide multi-channel capability, programmable temperature control and/or integrated signal processing capabilities for use in the fields of pharmaceuticals, biotechnology, quality control, drug discovery, clinical chemistry and macromolecular chemistry.

### SUMMARY OF THE INVENTION

In one aspect, the present invention relates to a multi-channel acoustic measurement device, which includes a plurality of acoustic detectors and programmable temperature control. The device employs piezoelectric crystal as the sensing material in the detectors and has a driving device connected to the detectors for driving the piezoelectric crystals. The device may also include a user interface.

In a second aspect, the present invention relates to a method of using a multi-channel acoustic measurement device of the invention to test at least one property of a plurality of samples in parallel.

### BRIEF DESCRIPTION OF THE DRAWINGS

FIG. 1 is a perspective view of one embodiment of a multi-channel acoustic measurement device in accordance with the present invention.

FIG. 2 is an exploded view of the thermal block of the multi-channel acoustic measurement device of FIG. 1.

FIG. 3 is an exploded view of a detector assembly for use in the multi-channel acoustic measurement device in accordance with the present invention.

FIG. 4 is a diagram of an oscillator circuit for use to oscillate the detectors of the present invention.

FIG. 5 is a flow chart showing the operation of an oscillator circuit for use in the present invention.

FIG. 6 is top view of a heater for use in the cover of the device of FIG. 1.

FIG. 7 is a cross-sectional view of the device of FIG. 1 along line 7-7′ of FIG. 1.

FIG. 8 is a schematic representation of the steps employed to make a simple measurement using the device of one preferred embodiment of the present invention.

FIG. 9 is a schematic representation of the steps employed to make an amplitude/phase feedback measurement.

FIG. 10 is a schematic representation of the steps employed to make a direct decay measurement.

FIG. 11 is a schematic representation of the steps employed to make a phase frequency spectrum measurement.

FIG. 12 is an exploded view of the thermal block and detector assemblies of an alternative embodiment of a device of the present invention, which includes fifty detector assemblies.

FIG. 13 is a circuit diagram of one embodiment of A/D-D/A circuits and power supply.

FIG. 14 is a flow diagram of one embodiment of a multiplexing system in accordance with the present invention.

FIG. 15 is a top view of an alternative embodiment of a portion of a detector assembly in accordance with the present invention.

FIG. 16 is a cross sectional view taken along line 16-16′ of FIG. 15.

FIG. 17 is a schematic representation of an automatic sampling device in accordance with the present invention.

FIG. 18 is a schematic representation of a phase-locked loop measurement method in accordance with the present invention.

FIG. 19 is a schematic representation of a multi-channel parallel measurement method in accordance with the present invention.

FIGS. 20A-20C depict the details of one embodiment of a detector element in accordance with the present invention.

FIG. 21 depicts a suitable counter circuit, which can be employed in the device of the present invention.

FIG. 22 depicts a suitable micro-controller and communication unit which can be employed in the device of the present invention.

### DETAILED DESCRIPTION OF THE PREFERRED EMBODIMENTS

The present invention relates to a multi-channel acoustic measurement device, which includes a plurality of acoustic detectors for the purpose of testing multiple samples in parallel. The device of the present invention may be employed, for example, to determine resonant frequency change, dissipation change, complex impedance, phase change, changes in signal amplitude, Q-factor or any combination thereof. These parameters may be determined as a function of temperature and/or time.

Based on the determination of one or more of the above-mentioned parameters, a variety of physical and chemical properties of the samples can be determined. For example, properties such as mass, visco-elasticity, glass transition temperature, kinetic cascade patterns, binding factor, biosensor specific concentration, and particle size can be determined. Also, detection of materials produced by cells, antibodies, organisms or enzymes may also be carried out using the device of the invention.

The device of the invention may be employed in the qualitative or quantitative determination of proteins, protein components, kinetics such as real-time kinetics of a polymerase chain reaction (PCR) process, drugs including coagulants, anti-coagulants, PT, PTT, and endotoxins, bioburden, pyroburden, micro-dissolution of compounds embedded in macromolecules, radiation-induced changes relative to UV, IR, VIS, X-ray, particle beams microwave (for example its utilization in the microwave damage study of cells in real-time of cellular telephone devices), thermal cycle induced crystal formation, thermal cycle specific chemical & biological processes, and mass, viscosity, elasticity and visco-elastic changes due to physico-chemical reactions. Endotoxin measurements can be employed, for example, for Sepsis detection.

In a broad sense, the device of the invention includes a plurality of acoustic detectors located in programmable temperature-controlled sample chambers, each of which detectors is interfaced with control circuitry. A programmable controller is configured to integrate the system and interface with a microprocessor. Optionally, signal processing may be employed to improve precision, accuracy, sensitivity and dynamic range. As a result, this device can be employed for monitoring or quality control of a variety of physical and chemical processes applicable in at least the pharmaceutical, biotechnology, medical, environmental, and polymer industries. The device can also be employed in the drug discovery, clinical chemistry and macromolecular chemistry fields.

In one embodiment of the invention, the device can be employed to provide an automated method for the qualitative or quantitative determination of the presence of endotoxins. This can be accomplished by, for example, measurement of gel firmness. Important advantages of the present device are that (1) it can be designed to be fully compliant with U.S. Food and Drug Administration standard 21 CFR Part 11 and (2) it can provide automatic gel firmness measurement instead of the manual examination as is currently being done.

In another embodiment of the invention, the device can be employed to provide an automated method for the qualitative and/or quantitative monitoring of the environment. Such a device can, for example, be employed to monitor various properties of endotoxins, pollutants, and other substances present in a given environment or sample.

In another embodiment, the device of the present invention can be employed for monitoring or measuring various aspects of high throughput micro-dissolution studies. Such a device can provide an automated method for the qualitative and/or quantitative measurement or monitoring of properties relating to the micro-dissolution of compounds. This device is particularly useful for studying the micro-dissolution of compounds embedded or encapsulated chemically or physically into drug delivery systems.

In yet another embodiment, the present invention can be employed for the purpose of detecting radiation-induced changes in measurable parameters of various materials. Such a device can be employed for the purpose of qualitative or quantitative monitoring of macromolecular changes in such materials.

In a still further embodiment of the present invention, the device can be employed to provide an automated method for the determination of coagulation kinetics, coagulation cascade pattern, classification of coagulation processes, coagulation endpoints, and various properties of coagulants and anti-coagulants. For example, the device can be employed for the quantitative or qualitative monitoring or measurement of properties of fibrinogen, heparin, heparin derivatives, Low Molecular Weight (“LMW”) heparin, LMW heparin derivatives, Thrombin Times (“PT”), Partial Thrombin Times (“PTT”), visco-elastic properties of blood for complex diagnosis in combination with the above parameters, and other similar materials, as well as the effects thereof when used as therapeutic agents.

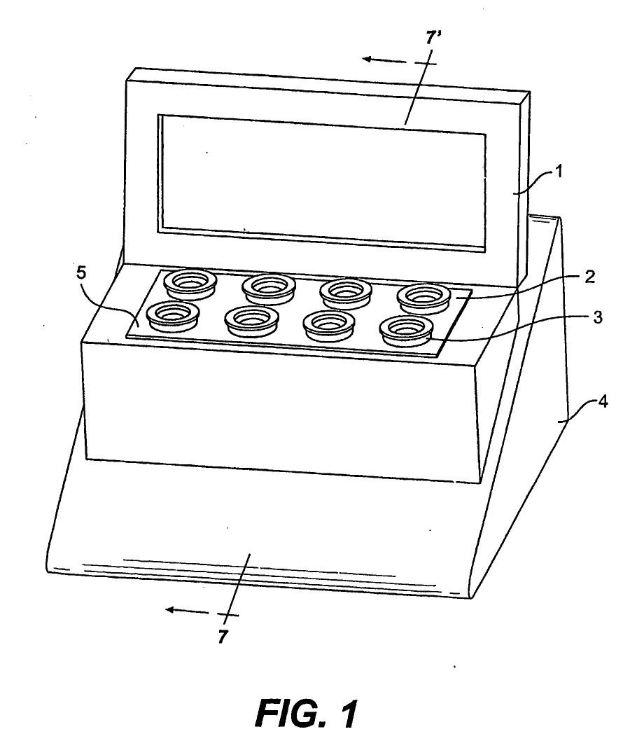

Referring now to FIG. 1, there is shown a first embodiment of a multi-channel, acoustic measuring device in accordance with the present invention. The device depicted in FIG. 1 includes a cover 1, a thermal block 2, a plurality of detector assemblies 3 and a base 4. Base 4 includes a rectangular slot 5 for receiving the thermal block 2 therein. Temperature regulated cover 1 is shown in the open position but can also be rotated down on, for example, hinges (not shown) to cover over the thermal block 2 and detector assemblies 3. Thermal blocks 2 may be interchangeable to provide ease of replacing detector assemblies 3 as a complete set. Also, detector assemblies 3 may be removable from thermal block 2 to exchange single detector assemblies 3, if desired, for cleaning and replacement.

Thermal block 2 may also include temperature sensors, not shown, embedded or located at various locations therein to determine the temperature profile of the thermal block 2. Temperature sensors may also be embedded or located at various locations in cover 1 to determine the temperature profile of cover 1. Temperature sensors can be employed for a closed loop temperature control system, for example. Cover 1 may also include a temperature-controlled glass cover plate to cover detector assemblies, allow viewing of the detector crystals through the cover and provide light protection if low actinic or appropriately cover filler or refractor is utilized.

The device may include two or more detector assemblies 3 and preferably includes at least five detector assemblies 3, more preferably, at least twenty-five detector assemblies 3, and, even more preferably, at least fifty detector assemblies 3. It is possible to construct devices with one hundred or more detector assemblies 3, or standard microplate configuration geometry of 8×12 (standard 96-well plate geometry), or 16×24, or higher densities, particularly for use in high-throughput analysis or for screening large numbers of compounds or materials.

The base 4 may be constructed of any suitable material such as aluminum, plastics, etc. The primary function of the base 4 is to support the remainder of the device and to house the various electronic components of the device. Preferably, the base is constructed in such a way that the detector assemblies 3 and/or thermal blocks 2 are easily removed and replaced without having to make complex electrical connections.

The thermal block 2 is preferably made of a heat-conductive material such as aluminum since thermal block 2 functions to distribute heat to the detector assemblies 3 in order to provide temperature control to the measuring device. Thermal block 2 is preferably designed to be removably inserted into base 4 to allow removal, cleaning and replacement of thermal block 2 and/or the various components contained therein. A suitable means (not shown) such as a handle may be provided for removing thermal block 2 from base 4.

Cover 1 is employed to close the device when not in use in order to protect the detector assemblies 3 from contamination or exposure to potentially harmful environmental conditions. Cover 1 also functions to isolate detector assemblies 3 from the environment during use of the device to minimize exposure of the detector assemblies 3 to air, moisture and other potential contaminants, which could adversely affect measurements, also the cover can be hermetically sealed for controlled gas purging, which can be used for calibration purposes, or exclusion of reactive gases, or inclusion of gases, such as carbon dioxide, or others, required for specialized analysis. Cover 1 is also preferably fabricated to include a heat-conductive material since another function of cover 1 will be to distribute heat to the various detector assemblies 3 when the device is in use. Further details regarding cover 1 are provided below.

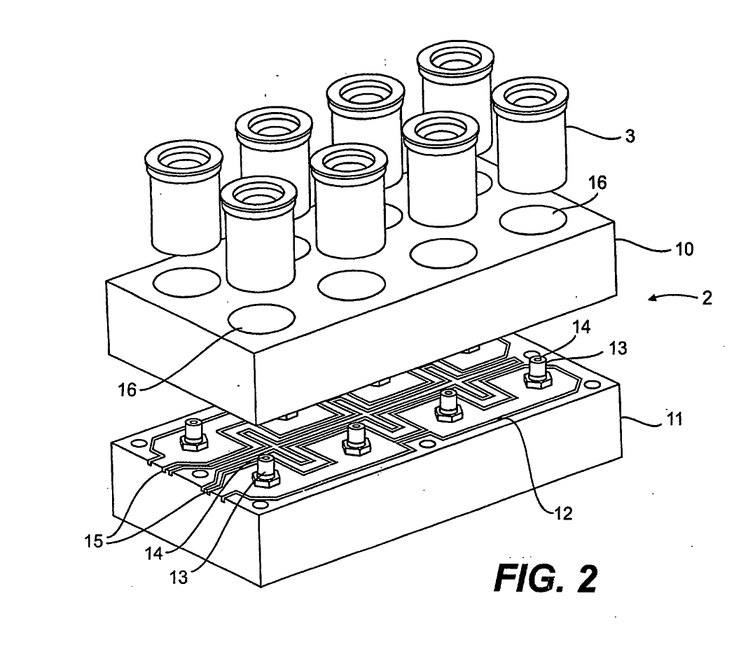

Referring now to FIG. 2, there is shown an exploded view of the thermal block 2. As can be seen from FIG. 2, thermal block 2 is preferably formed from an upper part 10 and a lower part 11, each of which may be fabricated from a heat-conductive material such as aluminum. Upper part 10 serves as a holder for supporting and holding detector assemblies 3 in place in thermal block 2, and upper part 10 also distributes heat from heating element 12 in lower part 11 to detector assemblies 3 when the device is in use. To accomplish these goals, upper part 10 includes a plurality of recesses 16 for receiving the detector assemblies 3.

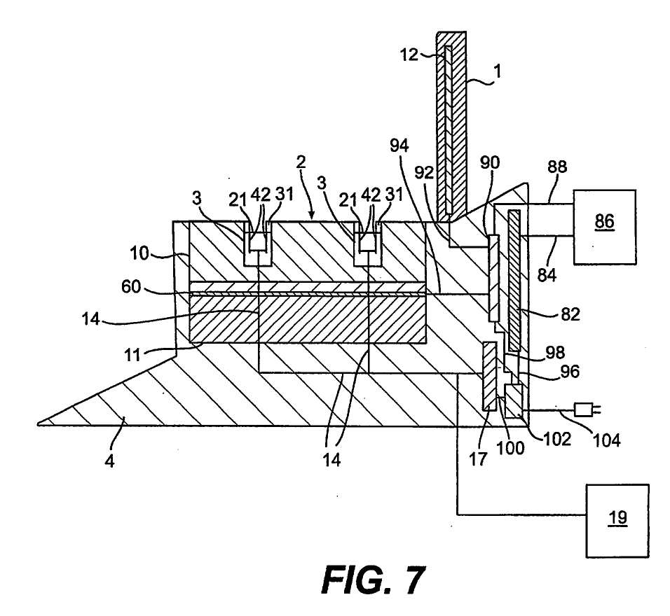

Lower part 11 is preferably provided with supports 13 which are designed to support detector assemblies 3 in position on lower part 11. In addition, electrical connections between detector assemblies 3 and data gathering devices, shown in FIG. 7, preferably run through the bottom of detector assemblies 3 and into supports 13 in lower part 11. For this purpose, supports 13 preferably include one or more electrical and data connections 14 for connection to the underside of detector assemblies 3.

Heating element 12 is preferably a resistance-heating element which may be electrically connected to the base 4 by electrical connections 15 to provide electrical power for heating the heating element 12. Electrical connections 15 are preferably designed to permit easy removal and replacement of thermal block 2.

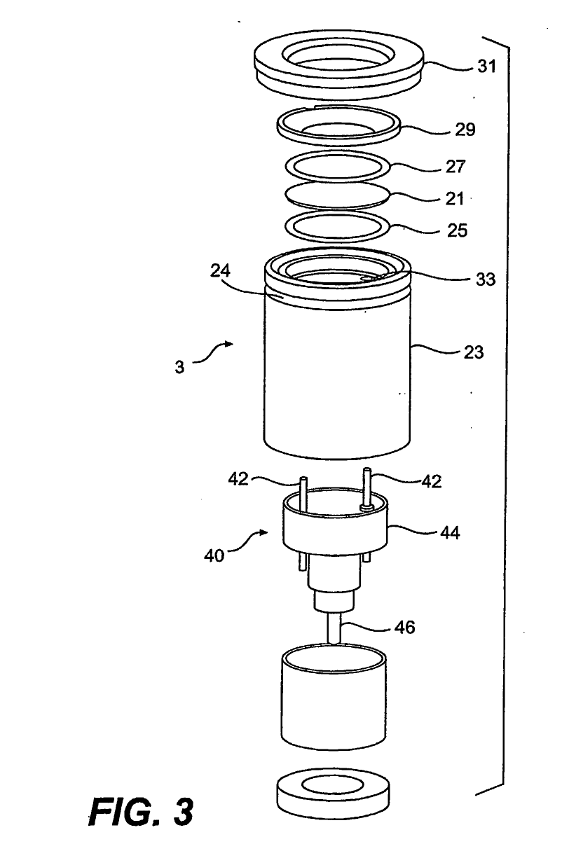

Referring to FIG. 3, there is shown an exploded view of a detector assembly 3 in accordance with one embodiment of the present invention. The detector assembly 3 includes a detector crystal 21. Detector crystal 21 is housed in detector head 23 and may be held in position by sealing rings 25, 27. Preferably, an additional ring 29 is included to position, hold and seal detector crystal 21 in detector head 23. Ring 29 may be held in position by screw cap 31 which attaches to the top of detector head 23, preferably by threaded engagement with threads 24 on detector head 23. Detector 23 may be of sealed screw cap with gas purging inlet to be used to control reaction environment during testing. Ring 29 may also serve as an insulator and can be properly positioned in detector head 23 by insulator positioning pin 33. Detector assembly is designed of elements having geometry to carry out the testing in sterile and endotoxin free environments.

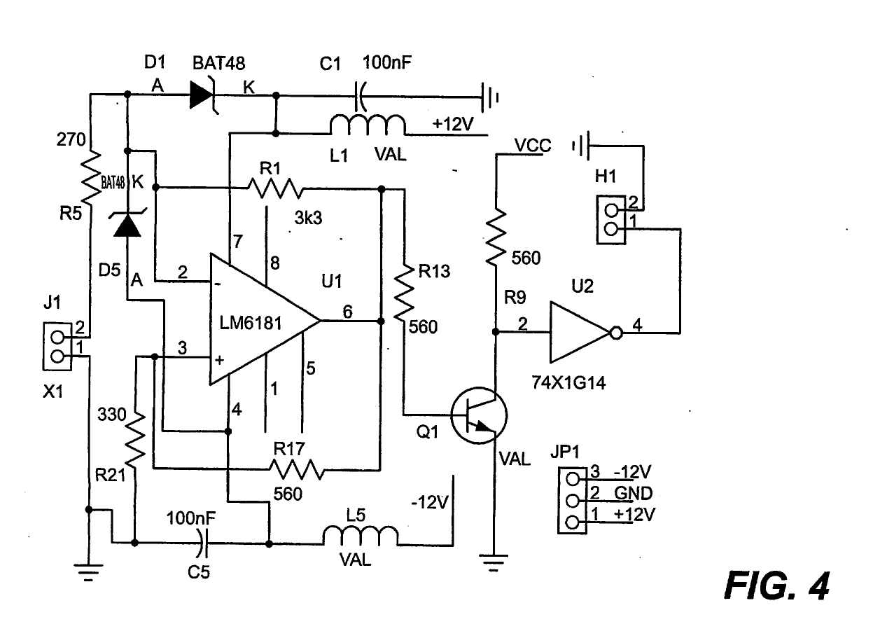

The detector assembly 3 also includes a driver connection 40 for the purpose of driving detector crystal 21 when the device is in use. Driver connection 40 includes a pair of crystal contacts 42 and a holder 44 for holding crystal contacts 42 in place. In operation, crystal contacts 42 contact detector crystal 21 and cause a perturbation as a result of driver connection 40 and the action of, for example, an oscillation circuit as shown in FIG. 4. Driver connection 40 is connected to an oscillation circuit via male connector 46, which is designed to mate with electrical connections 14 of supports 13 in the lower part 11 of thermal block 2. In the embodiment of the device shown in FIG. 3, each detector assembly 3 is connected to its own oscillator circuit.

A spacer 48 is provided to permit a bottom-closing cap 50 to seal off the bottom of detector assembly 3. Spacer 48 and bottom closing cap 50 can alternatively be integrally formed into a single element.

Detector crystal 21 is a piezoelectric crystal. More preferably, detector crystal 21 is selected from quart crystals, such as are used in a quartz crystal microbalance (QCM) measuring device, gallium phosphide crystals, and other similar piezoelectric crystalline materials.

The driving device for perturbing the detector crystal 21 may be any suitable driving device. For example, the driving device may be an oscillator, a digital data sensitizer or a fourier transform frequency generator. Different driving devices may offer specialized advantages for particular applications, such as, for example, increased sensitivity of certain measurements. Also, the oscillator is typically a non-continuous driving device, whereas the digital data sensitizer and fourier transform frequency generator may be employed in a continuous manner. To obtain a fingerprint of a particular material, for example, a fourier transform frequency generator can be employed and the signals from the fourier transform frequency generator can be perturbed to provide non-harmonic signals that can be employed to obtain additional details about the sample.

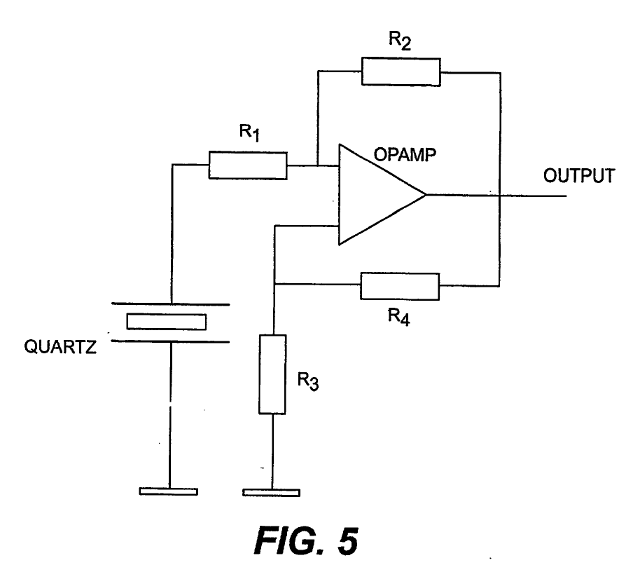

FIG. 4 shows an example of a suitable oscillator circuit for the device of the invention. The logic of the oscillator circuit is shown in FIG. 5 wherein R₁, R₂, R₃ and R₄ are resistors, and “Quartz” represents a detector crystal 21. Detector crystal 21 is preferably connected to an inverting input of a high speed and high slow rate operation amplifier. The positive feedback through R₂ produces a 180° phase shift. R₃ and R₄ stabilize the amplifier and adjust gain via negative feedback loop. R₁ limits the input current. The output is preferably conditioned to a TTL level.

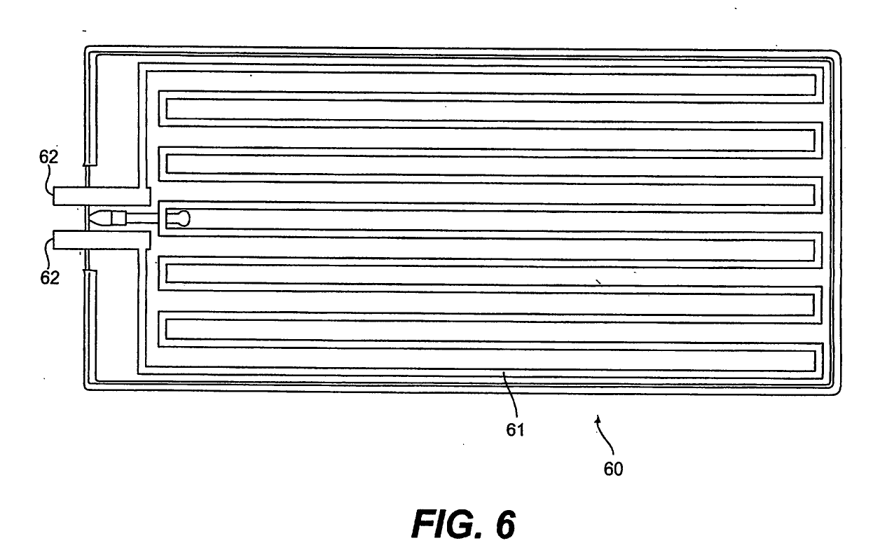

FIG. 6 depicts a heater 60, which can be employed in cover 1 of the device of the present invention to provide heating of the detector assemblies 3 via cover 1 in addition to the heating provided by heating element 12 located in the lower part 11 of thermal block 2. Heater 60 is preferably includes a resistance heating element 61 and thus includes electrical contacts 62 for connection of heater 60 to a power source as shown in FIG. 7. Heater 60 may be coated with filler or refractive materials for light protection during the measurement process.

In a preferred embodiment, heater 60 cooperates with heater 12 to provide temperature control for the environment in which the detector assemblies 3 are located. In this embodiment, heaters 12, 60 are controlled by a programmable control unit that controls the temperature of the detector assemblies 3. In this embodiment, heaters 12, 60 can be operated to cooperate to provide a controlled temperature gradient over the cover 1 and heating block 2 whereby condensation from air trapped inside cover 1 can be prevented during operation of the device. Persons skilled in the art can determine an appropriate temperature profile for this purpose using dew point calculations. This feature of the device improves the accuracy, precision and repeatability of measurements made by the device since condensation can alter the sample in the detector assembly 3, thereby altering the results obtained from measurements of the sample.

FIG. 7 is a cross-sectional view of the device of FIG. 1 along line 7-7 of FIG. 1. FIG. 7 shows that electrical connections 14 connect crystal contacts 42 to oscillator circuit 17. Also, electrical connections 14 provide a means for transferring data via data connection 80 from detector assemblies 3 to data processing or data storage device 19. Oscillator circuit 17 is also preferably connected to multiplexing circuit 82 to provide multiplexing of the oscillator circuit 17 to a plurality of detector assemblies 3. In some embodiments, multiplexing circuit 82 is connected via a data connection 84 to a controller 86. Controller 86 is preferably a microprocessor, and, more preferably controller 86 is programmable to allow the user to select various forms of multiplexing depending upon the particular application of the device.

Controller 86 is preferably also connected via a data connection 88 to temperature control circuit 90. In this manner, a user can select various types of temperature control to be implemented by temperature control circuit 90. Preferably controller 86 includes a data input device to permit pre-programmed control programs to be inputted to controller 86 and used to control temperature control circuit 90. Similar pre-programmed control programs can also be employed to control multiplexing circuit 82, if desired. Temperature control circuit 90 is, in turn, connected via electrical connections 92, 94 to heaters 12, 60 to provide control of heaters 12, 60 during use of the device.

Each of oscillator circuit 17, temperature control circuit 90 and multiplexing circuit 82 may be connected via electrical connections 96, 98, 100 to a power supply 102 that can be interfaced with an external power source via power cord 104.

Measurements of various parameters such as frequency change, onset resonant frequency change, dissipation, dissipation change, complex impedance, phase change, change in signal amplitude, Q-factor or any combination of the above parameters, can be made using the device of the present invention. Properties of various analytes can be calculated from the calculation of the inflection point of the resonant frequency change, the rising of the resonant frequency change, the dissipation change, complex impedance, phase change, change in signal amplitude, Q-factor and any combination of these parameters. Quantitative measurements can be validated using mathematical modeling based on measurement uncertainty, utilizing a natural language graphical interface editor. The natural language graphical interface editor can be integrated by a dynamic HTML guide and HTML-controlled wizards. This car be employed, for example, to improve multiple language application conversion.

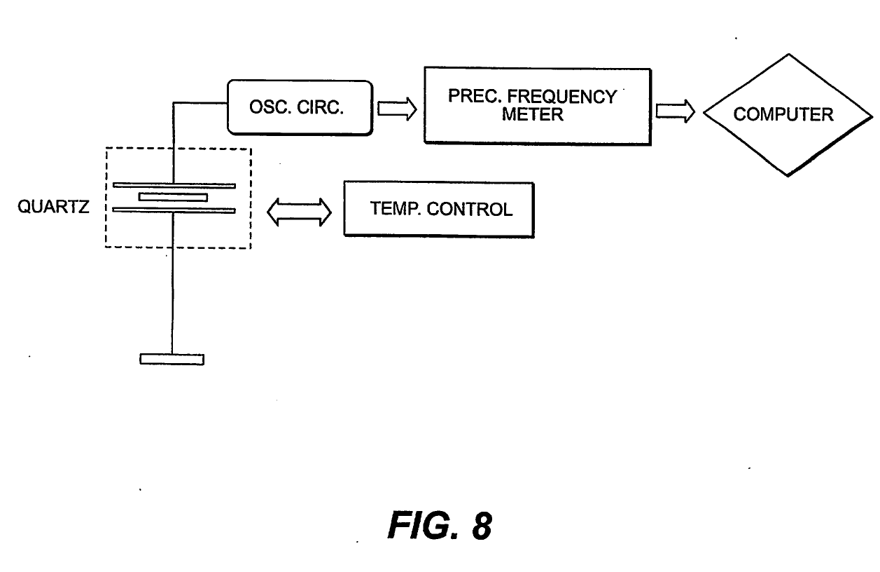

FIG. 8 is a schematic representation of the steps employed to make a simple measurement using the device of one preferred embodiment of the present invention. The basic driving device, such as an oscillator circuit, drives the crystal to the resonant frequency. A frequency counter measures the resonant frequency. The detector crystal is temperature controlled.

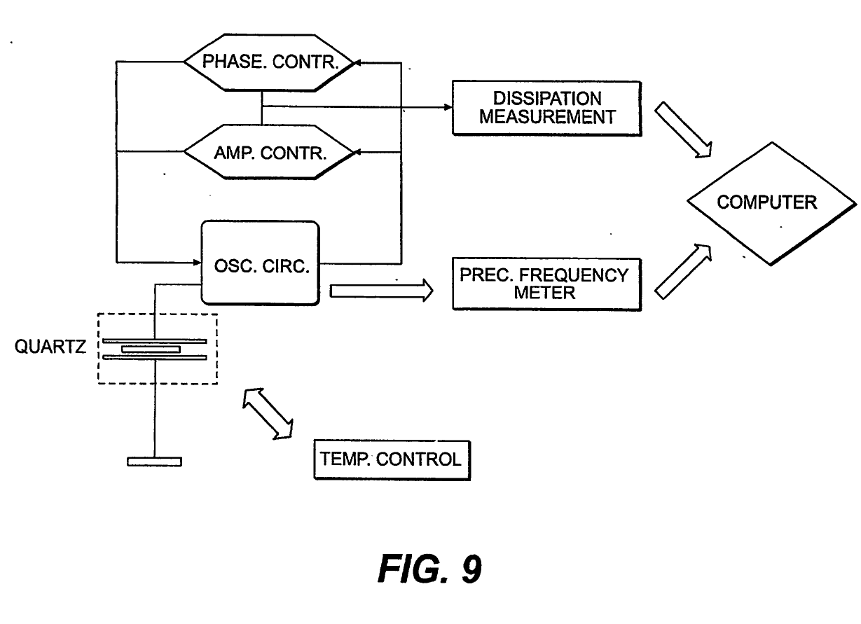

FIG. 9 is a schematic representation of the steps employed to make an amplitude, phase feedback measurement. A voltage driven oscillator is applied here. The feedback circuits drive the oscillator to a maximum amplitude and a minimal phase state. Dissipation can be calculated from the phase difference between the crystal and the driving excitation. A frequency counter is used to measure frequency. The computer can be used to control all circuits. The detector crystal is preferably temperature controlled.

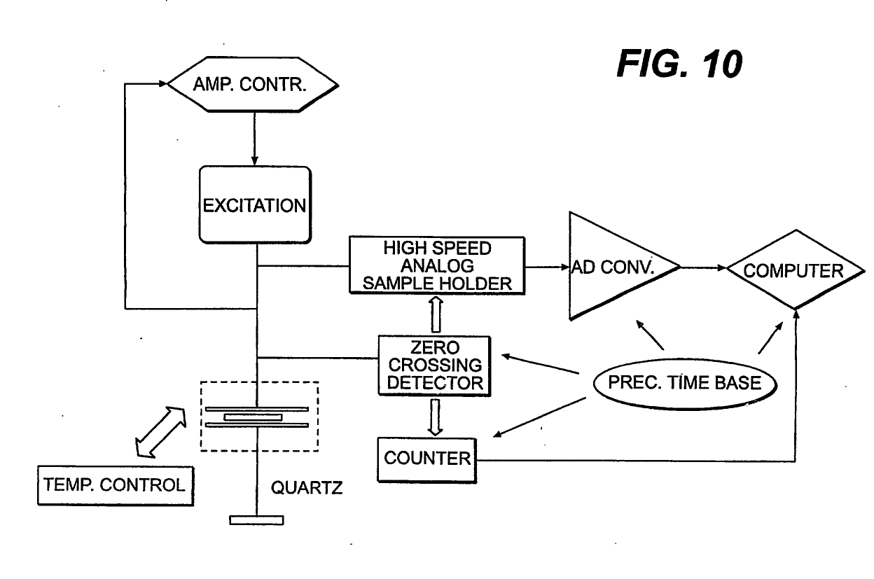

FIG. 10 is a schematic representation of the steps employed to make a direct decay measurement. In this embodiment, the detector crystal oscillates at its highest amplitude (resonant frequency). The excitation is switched off and it subsequently follows the decay of oscillation. A high-speed analog sample holder searches for the current amplitude maximum in every period of the decay curve. An A/D converter measures these maximums. After the maximum, the amplitude signal drops down and reaches the zero value (zero crossing). At this point the sample holder set to zero and the zero crossing counter is increased. The negative period is omitted. The measured points give the dissipation value (by exponential function curve fit). The zero crossing counter gives the frequency by comparing to an accurate time base.

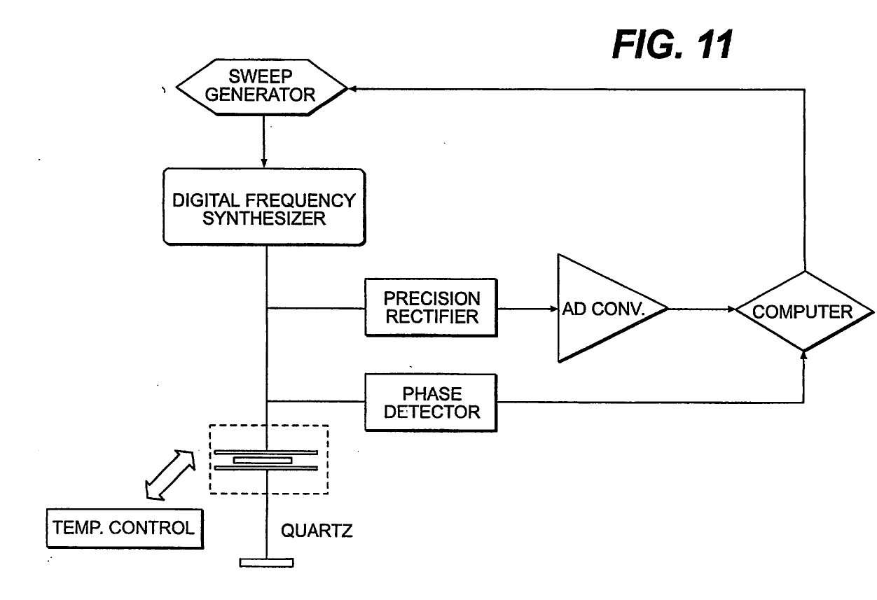

FIG. 11 is a schematic representation of the steps employed to make a phase frequency spectrum measurement. The detector crystal is excited by a frequency synthesizer. A rectifier produces the amplitude integration within given time constants. An A/D converter measures this signal. The computer sweeps the excitation frequency and records the amplitude and phase signals. These values construct the amplitude-phase vs. frequency spectrum.

The device described in FIGS. 1-7 has the further advantage that measurement of various properties of the sample can be accomplished without modification of the sample. This is a significant advantage in many systems since it allows further testing or processing of each sample since the sample has not been modified.

The detector crystals 21 employed in the device of the present invention are preferably piezoelectric crystals. Preferably, the detector crystals 21 are coated with one or both of titanium and/or gold, and/or other precious metals, such as silver, although it is possible to employ other biocompatible and/or conductive materials for coating detector crystals 21.

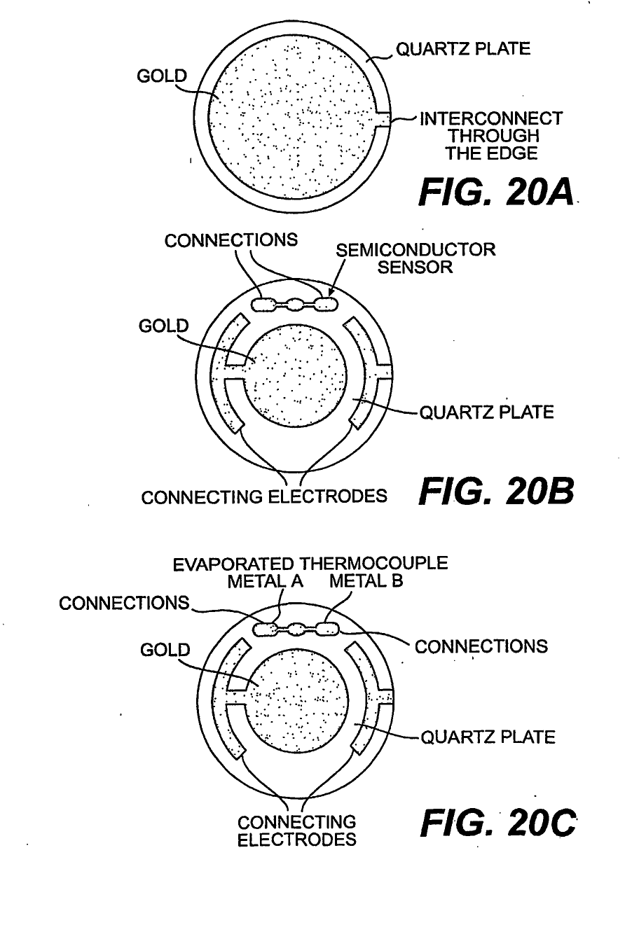

In addition, temperature sensors, such as thermocouple or thermistors can be deposited onto the surface as shown in FIGS. 20A-20C.

In addition, detector crystals 21 can be coated with an additional protective layer to extend their useful lifetime and to employ biosensor measurements. Suitable protective coating materials are biocompatible materials and include polystyrenes, cellulose acetate phthalate, acrylates such as methyl acrylate, propyl acrylate, butyl acrylate, and hydroxyethyl methacrylate, celluloses such as nitrocellulose, methylcellulose and hydroxypropyl cellulose, polycarbonates, polyethyleneimine, polyethylene terephthalate, cyclodextrins, carboxymethydextrans, Nafion® 117 and carboxylated polyvinyl pyrrolidone. Other suitable protective and biosensor functional materials may also be employed. It has surprisingly been found that application of such protective coatings do not adversely affect the performance of the detector crystals 21. For example, there is no noticeable loss in sensitivity. Moreover, such protective coatings do not necessitate any correction factors or require any other special considerations. As a result, the useful life of the detector crystals 21 may be extended in this manner without any serious disadvantage.

Coating of the crystals can be accomplished by spin coating. The crystals are first placed in PyroSpin™ crystal holders. The crystals are spun at low speed and a 5-100 microliter polymer or biosensor mix is delivered to the crystal, while spinning. After delivery of the solution is complete, the spin speed is adjusted to high speed for a sufficient time to complete the coating process. The coated crystals are then placed into a PyroPort™ crystal transporter and positioned in a PyroStrip™ programmable temperature chamber. The temperature chamber is programmed to provide a temperature profile from 4-150° C., and held for 30-180 minutes and then the coated crystals are allowed to cool. The vacuum pump is turned on and after the temperature cools to below 40° C., the vacuum is reduced sufficiently to permit opening the cover to remove the coated crystals.

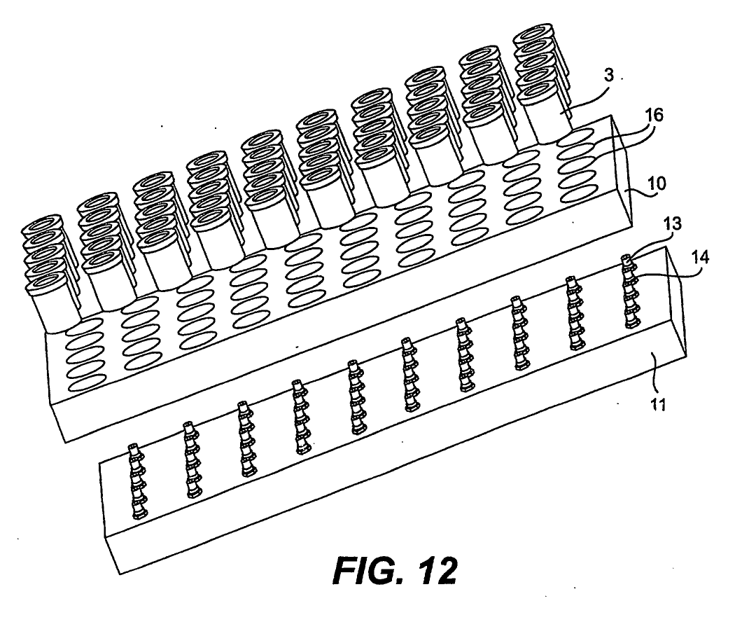

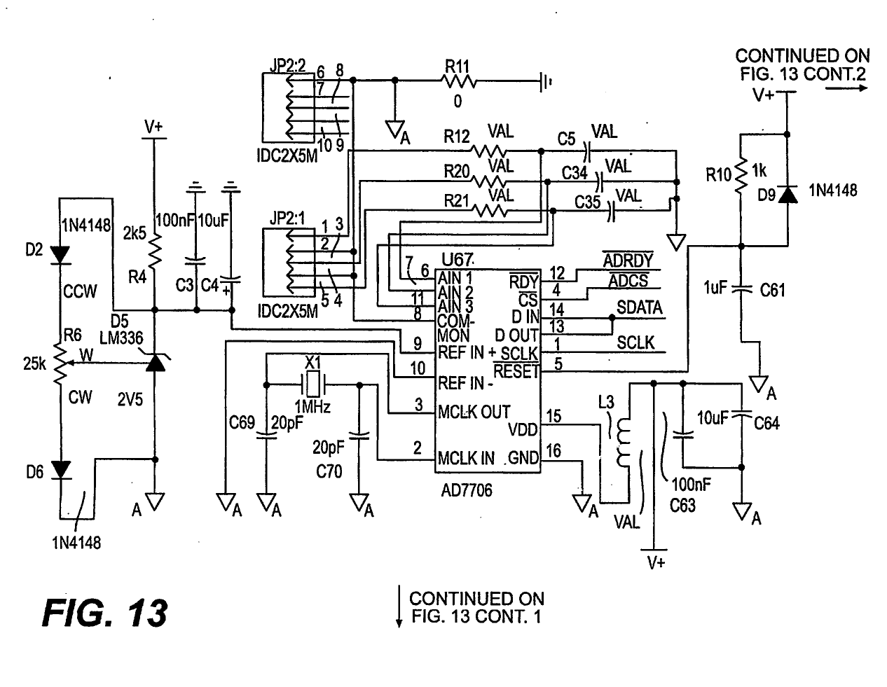

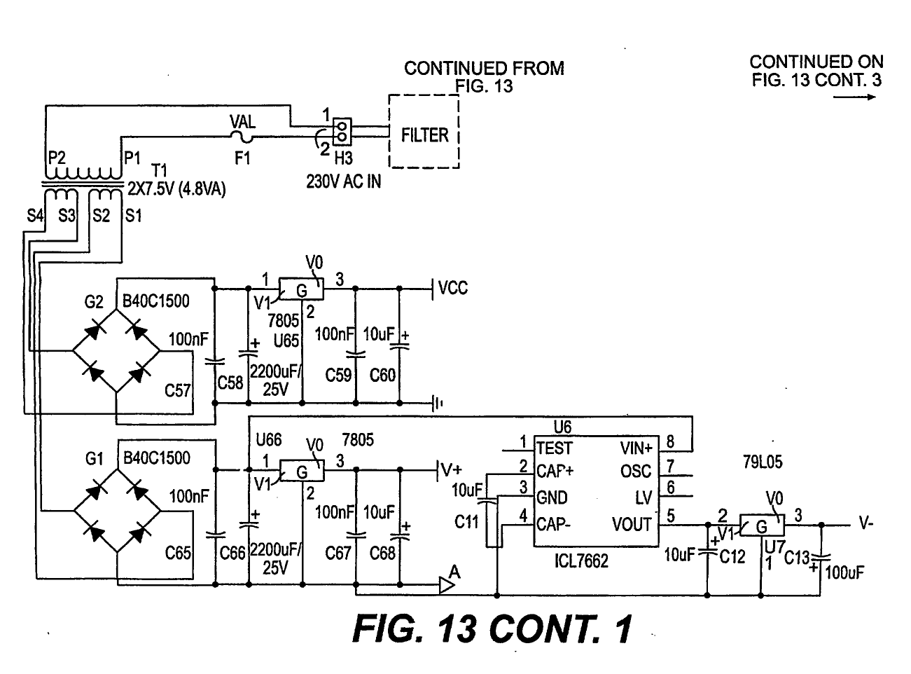

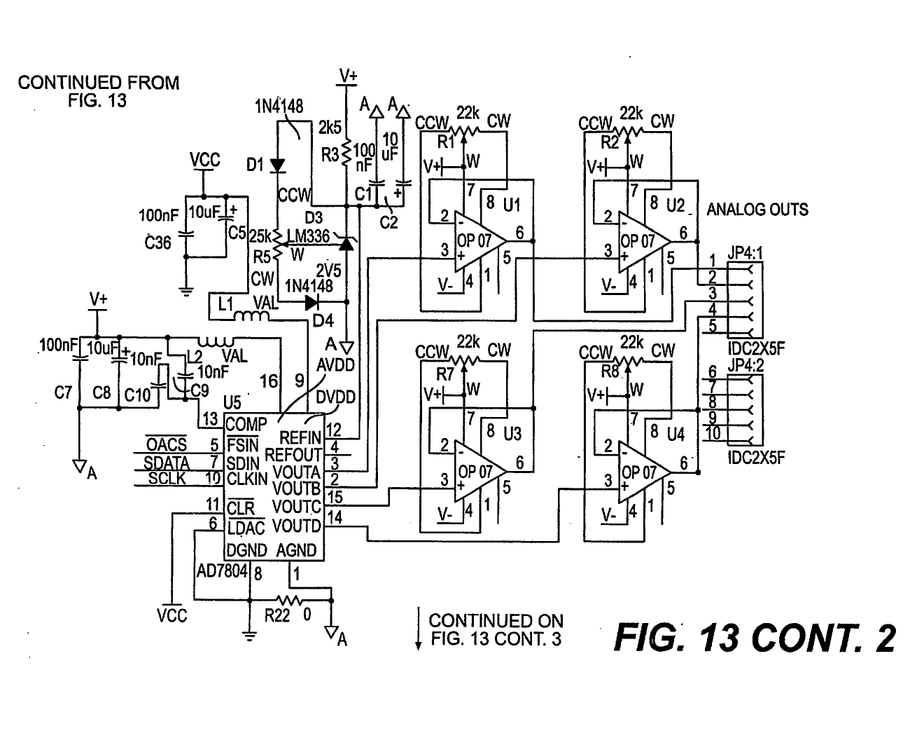

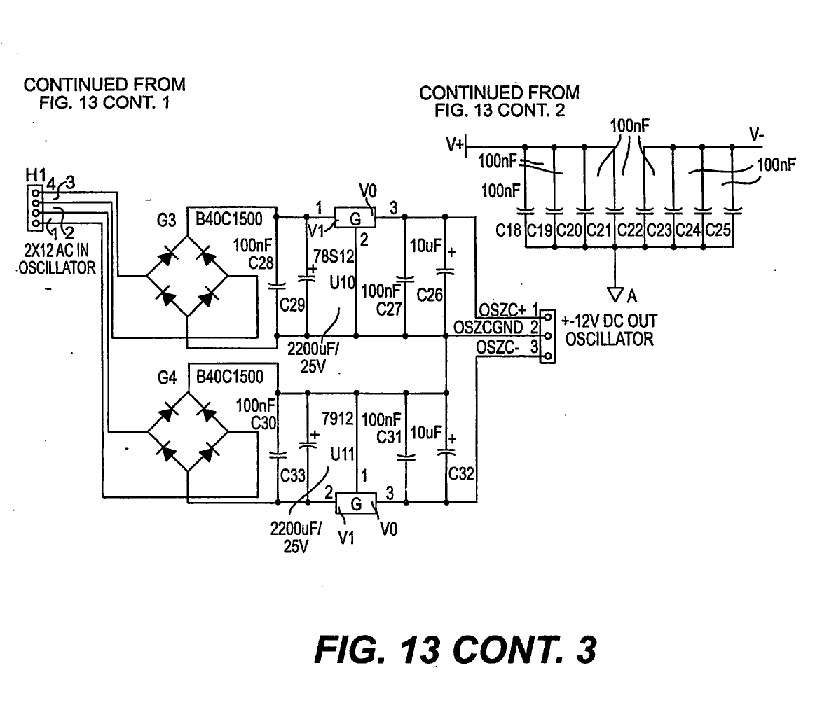

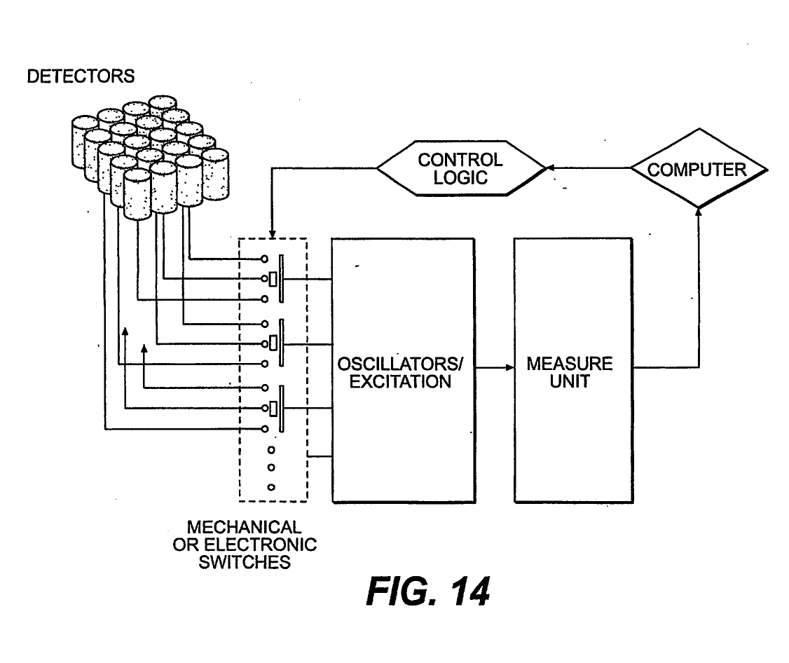

Referring to FIG. 12, there is shown an alternative embodiment of the device of FIG. 1, which includes fifty detector assemblies 3. In the embodiment of FIG. 12, it is desirable to employ only a single oscillator circuit or a small number of oscillator circuits since otherwise the size and cost of the device become quite large. In order to employ less oscillator circuits than detector assemblies 3, the device of the present invention may include a multiplexing shown, for example, in FIG. 14 for the purpose of multiplexing a plurality of detector assemblies 3 with a single oscillator circuit. In an exemplary embodiment, ten detector assemblies can be multiplexed with each oscillator circuit. FIG. 14 depicts one embodiment of a multiplexing circuit that can be employed in the device of the present invention.

FIG. 14 shows a schematic representation of one embodiment of the multiplexing methodology used in the device of the present invention. A five channel phase-locked loop (PLL) driving unit excites one column of multiarray detectors. A five channel, 1 to 10 multiplexer unit switches between the columns. The uC based control logic subsequently connects the measuring unit to every column of detectors. Five channels (one column of detectors) are measured at the same time. The multiplexer consists of either mechanical (REED relay) or electronic (analog switch) switches. All parameters can be measured and the device does not have a sensitive mechanical construction and thus is robust.

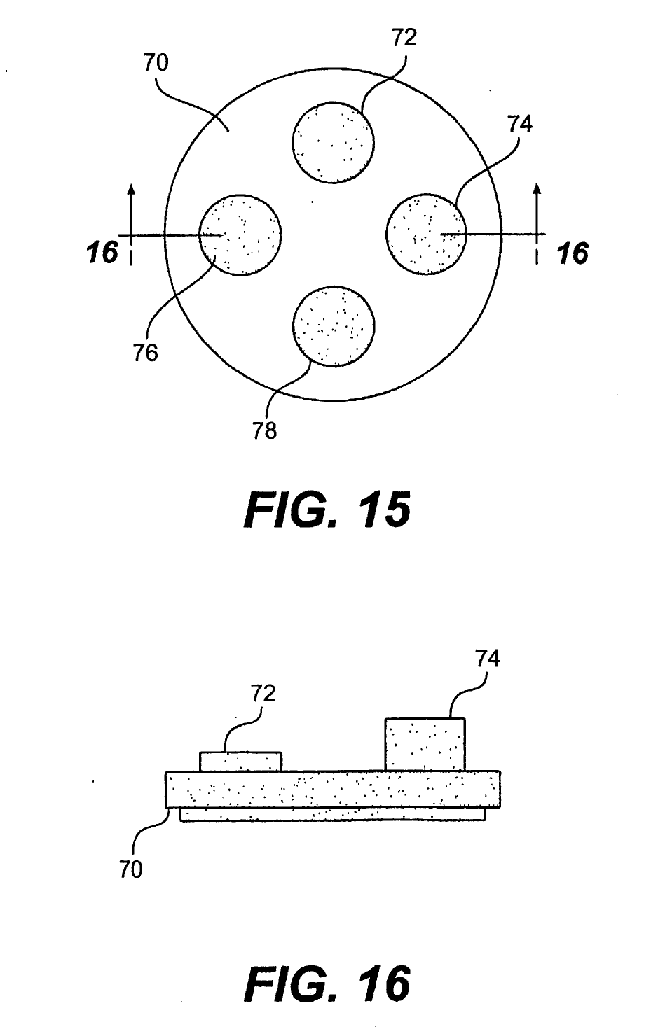

In another preferred embodiment of the invention shown in FIG. 15, each detector assembly 70 includes a plurality of detectors 72, 74, 76, 78 thereon. In this manner, each detector assembly 70 can be used to make a plurality of measurements on a single sample, thereby increasing the number of measurements possible with the device of the present invention, as well as providing the ability to increase the throughput of the device. As shown in FIG. 15, each detector assembly 70 employs four detectors 72, 74, 76, 78. However, it is possible to include practically any number of detectors on each detector assembly up to the physical limits of the manufacture of the detectors. Preferably, each detector assembly may include two or more detectors, more preferably, each detector assembly includes four or more detectors and, in some cases, it may be desirable to have up to one thousand detectors per detector assembly. Large numbers of detectors can be fabricated on a relatively small detector assembly using photolithography, for example.

As shown in FIG. 16, a more preferred embodiment of the device of FIG. 15 employs detector crystals 74, 76 having contacts of different thickness resulting in different frequencies. The appropriate thickness is tuned to suitable offset frequencies, which can be controlled during the deposition process. Each contact disk can be coated with specific sensor, i.e., chemical sensor and/or biosensor to facilitate taking different measurements from the same sample. The contact of greater height is coated with a different thickness of conductive material, such as gold, to provide the different heights. Each detector crystal 72, 74, 76, 78 can be its own sensor providing the same or different measurements utilizing frequency synthesizer, as desired. One or more detector crystals can be used as controls or reference sensors, if desired.

The use of a plurality of detectors on a single detector assembly, as shown in FIGS. 15-16 can be combined with any of the other embodiments of the invention to provide devices with as many as 100,000 detectors in a single device. In addition, the multiplexing circuit of the invention can be employed to multiplex the detector assembly with one or more oscillator circuits, to multiplex the detectors within a single detector assembly with one or more oscillator circuits or both.

The embodiments employing the detector assembly design of FIGS. 15-16 are particularly useful for multi-array bioreactors for high throughput screening of a variety of biological materials such as cells, enzymes, antibodies, and antigens, as well as products produced by such cells and enzymes, such as endotoxins.

In order to facilitate high throughput measurement, embodiments of the system of the present invention employ continuous flow detectors, not shown. Continuous flow detectors are known devices that are commercially available. Continuous flow detectors allow samples to flow through the detector element during measurement of one or more properties of the sample. Employment of such continuous flow detectors permits an even higher throughput of samples.

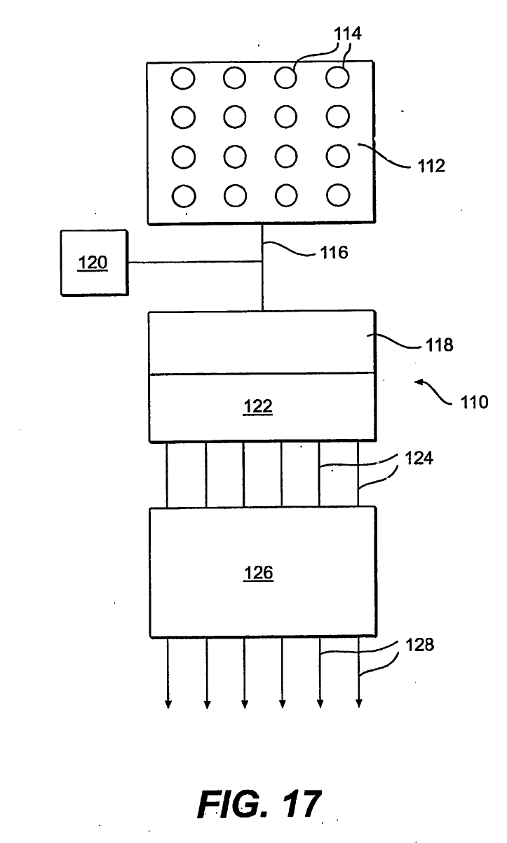

Also, some embodiments of the device of the present invention may further employ an automatic sampling device to provide such features as continuous sample injection and sample splitting. One embodiment of an automatic sampling device 110 is depicted schematically in FIG. 17. Automatic sampling device 110 may include a sample tray 112, which may be provided with a plurality of sample wells 114. Sample tray 112 is connected via a fluid connection 116 to a sample splitter 118. A pump 120 may be provided to move samples from sample tray 112 to sample splitter 118. Sample splitter 118 can be employed to split a single sample into multiple samples and these multiple samples can be fed from sample splitter 118 to a multi-position switching valve 122 which can provide samples via fluid connections 124 to flow-through detector array 126. Samples will then pass through flow-through detector array 126 to sample outlets 128 and can be further processed outside the device.

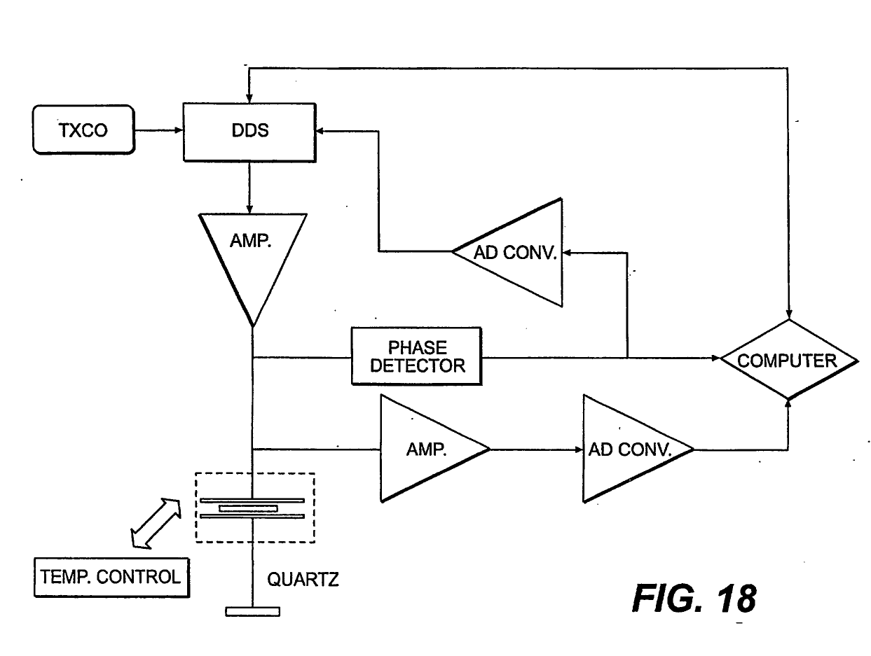

Referring to FIG. 18, there is shown a schematic representation of a phase-locked loop measurement method. In this method, the detector crystal is driven by a digital data synthesizer (DDS). Phase detectors measure the difference between the excitation and the crystal oscillation phase and try to minimize this difference by feedback trough an A/D converter. The accuracy is determined by the precision of the DDS, which is about 3-4 ppm. The dissipation value is outputted from the phase detector output and the DDS control value gives the resonant frequency. Combining this method with amplitude measurement provides a powerful measuring technique including all the parameters that are available in an acoustic measurement.

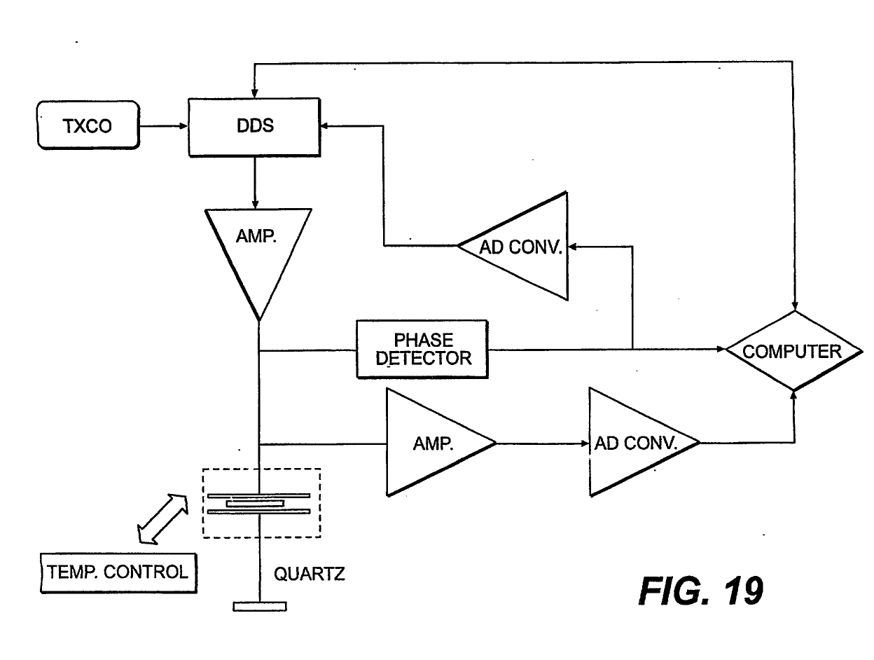

FIG. 19 is a schematic representation of a multi-channel parallel measurement method in accordance with the present invention. Regarding the transient effects and thermal instability, all oscillators are running parallel. Every channel has its own thermally stabilized oscillator and counter unit. The uC based device reads the counts out from the counter and transmits the readings to a computer for evaluation. All counters are triggered by a common time base generator, which provides the gate time for frequency counting. Sampling speed can be high due to the parallelism.

FIGS. 20A-20C show details of one embodiment of a detector element in accordance with the present invention.

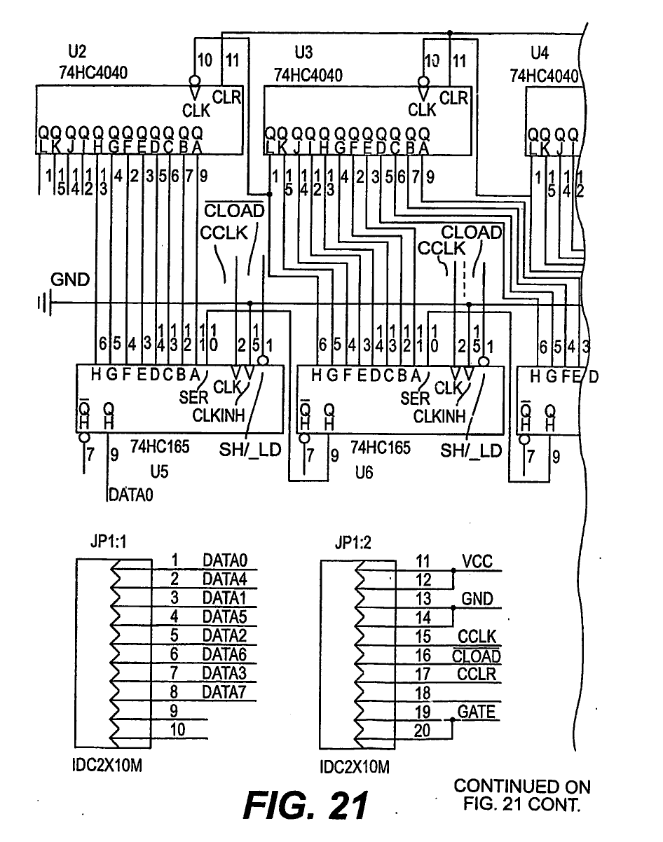

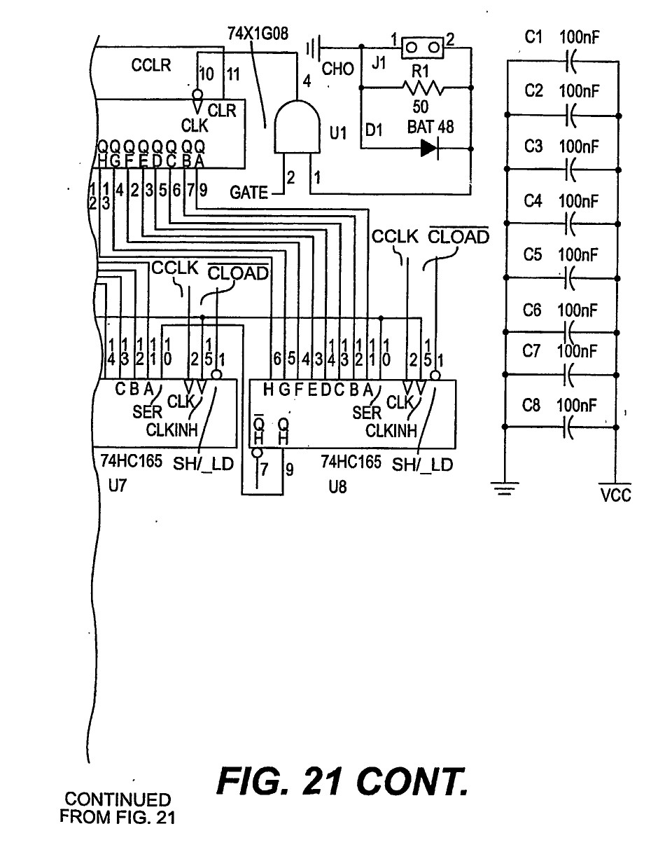

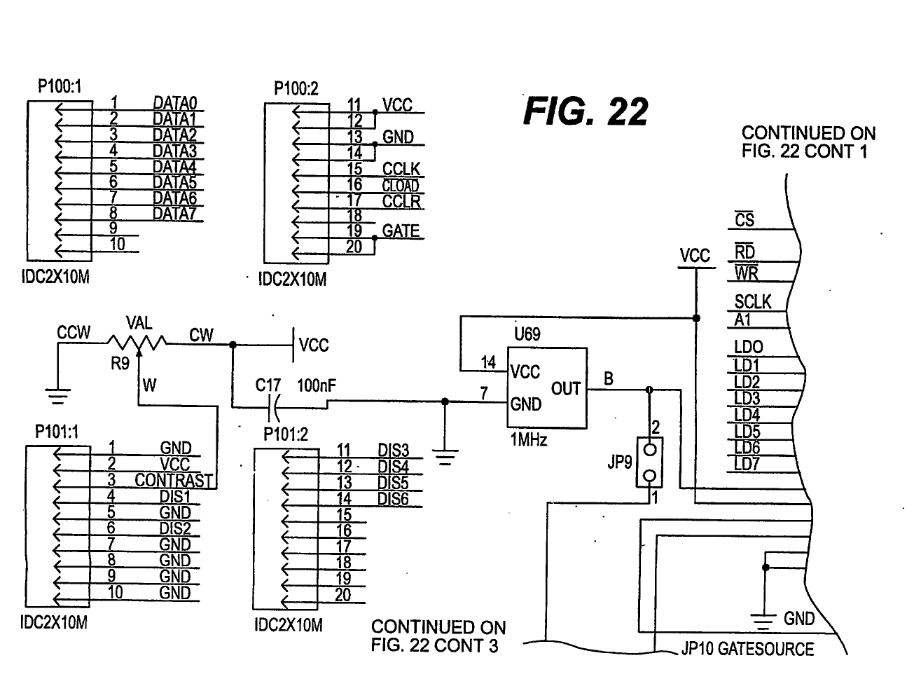

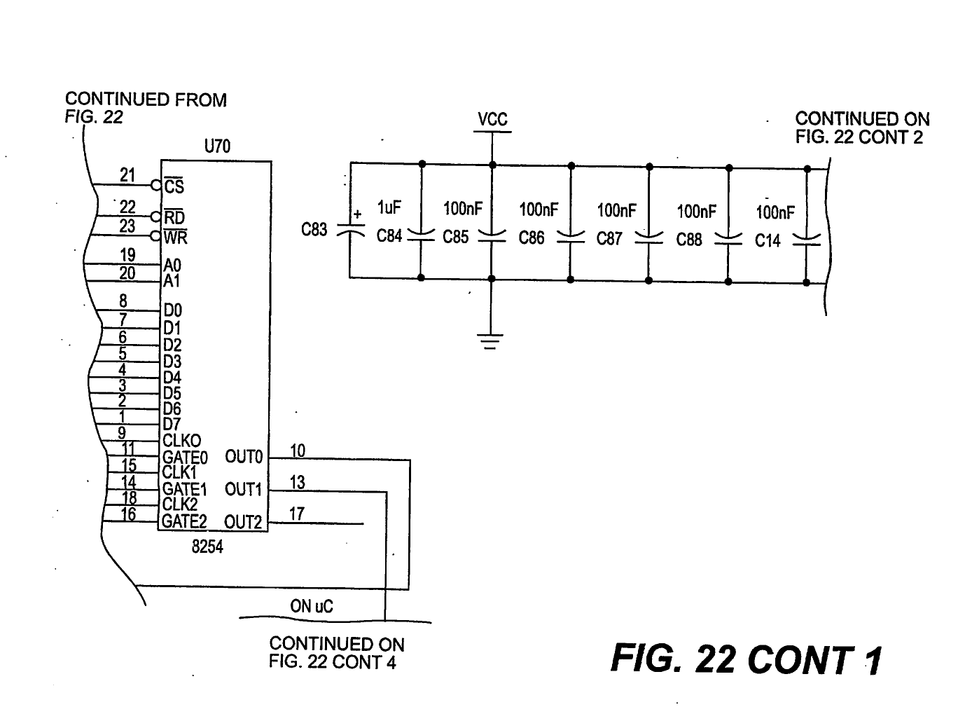

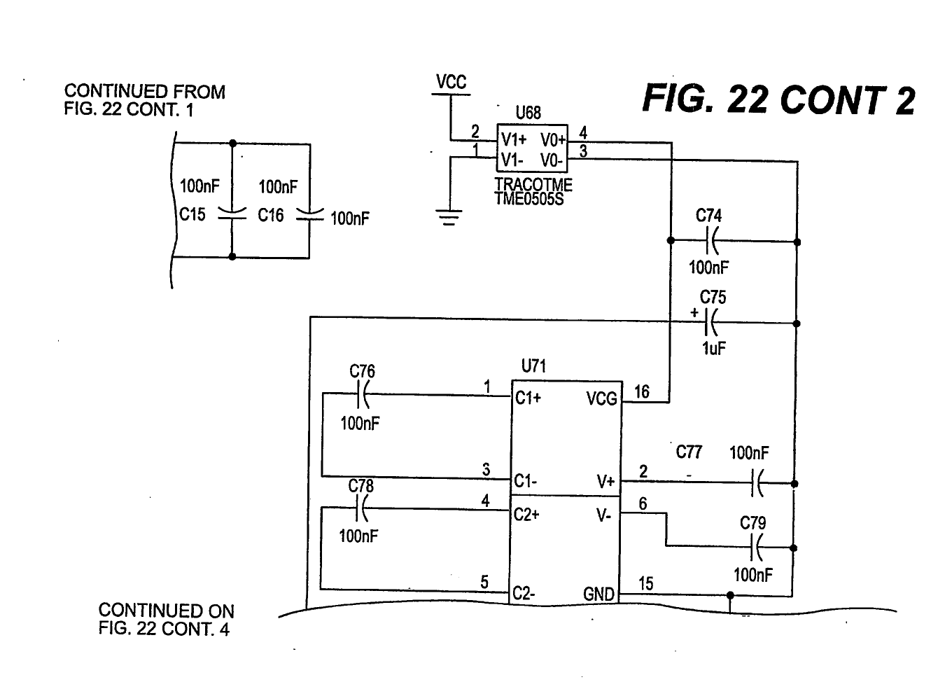

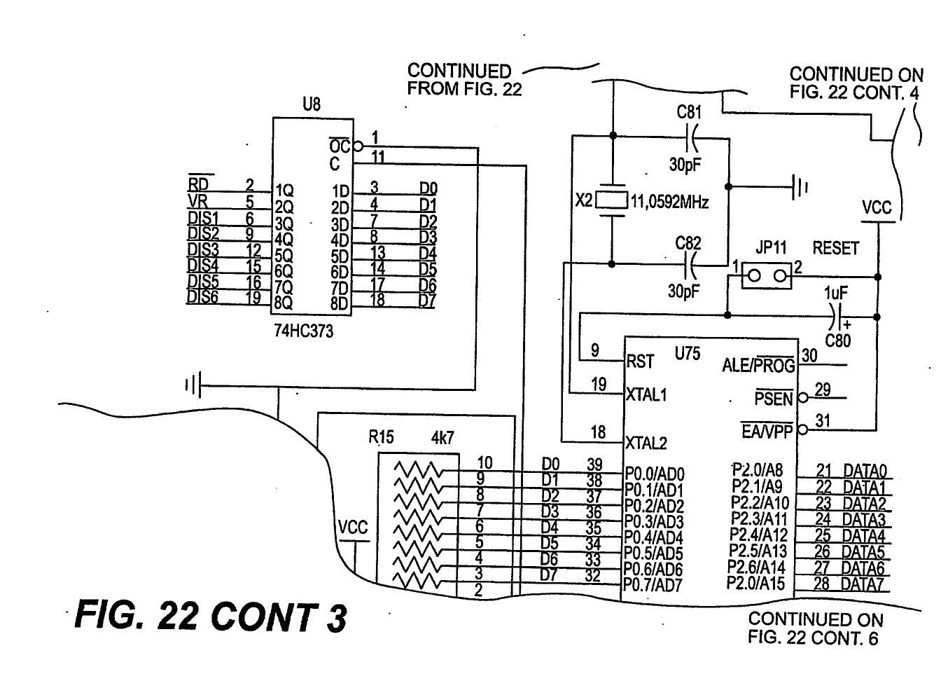

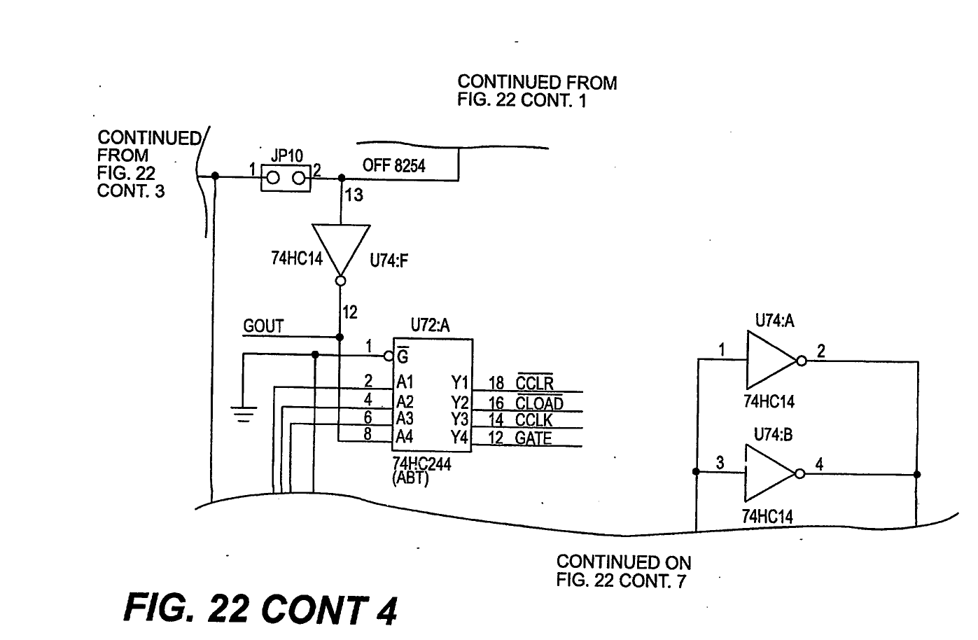

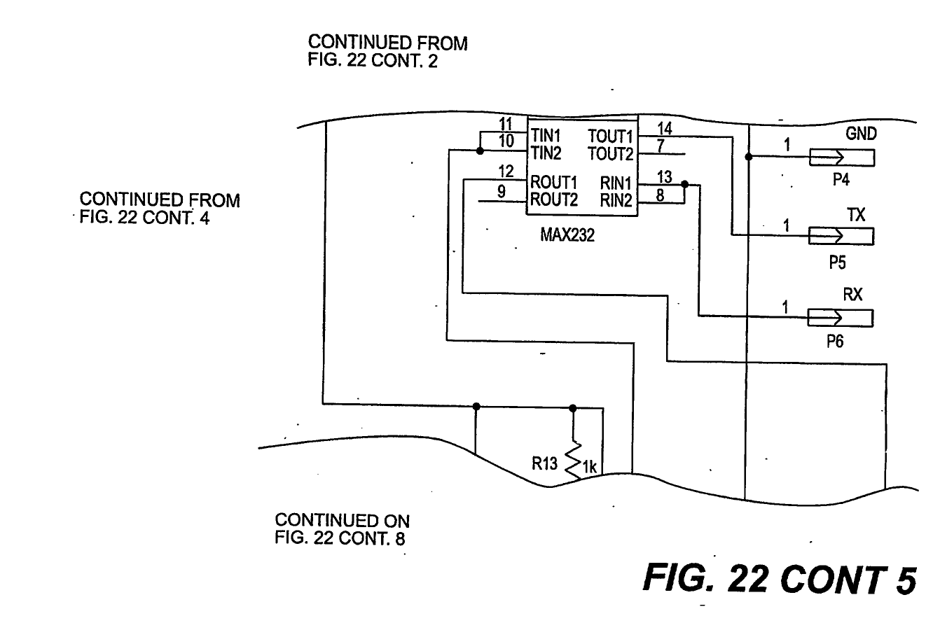

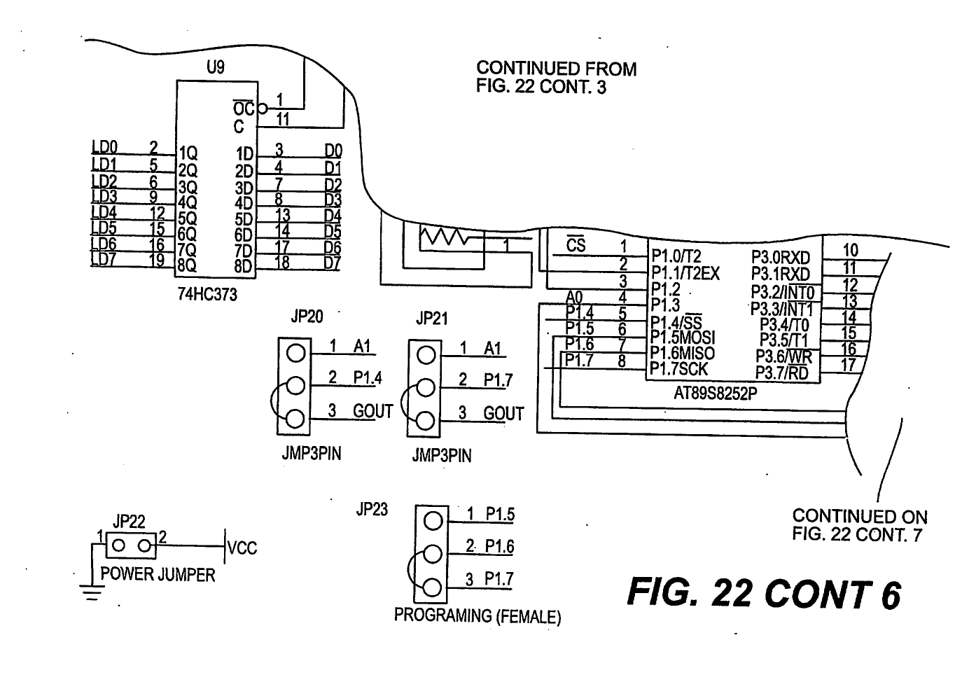

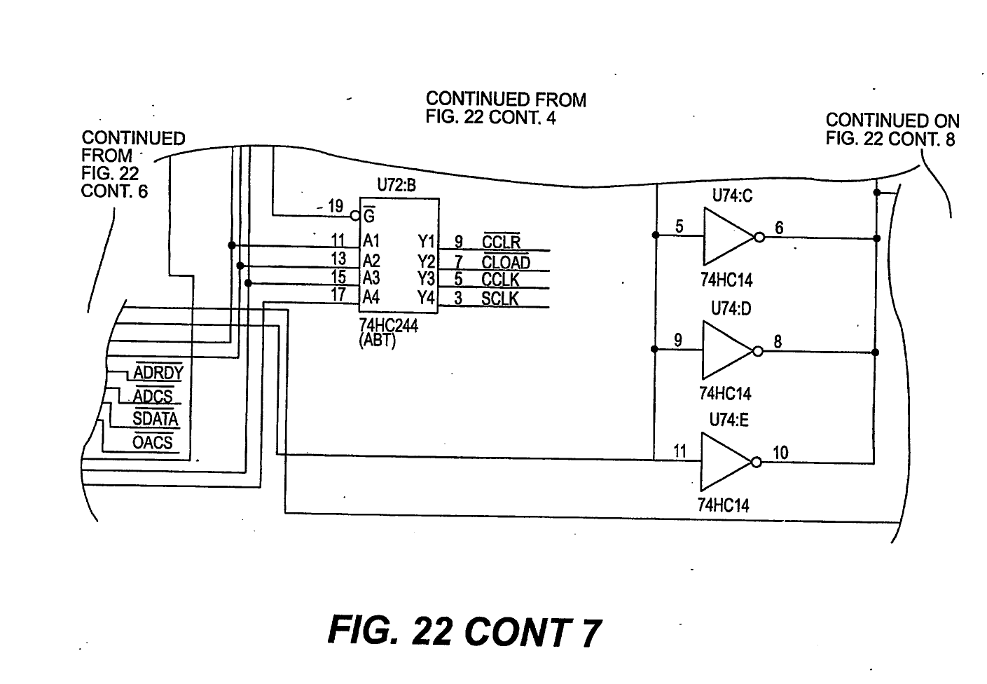

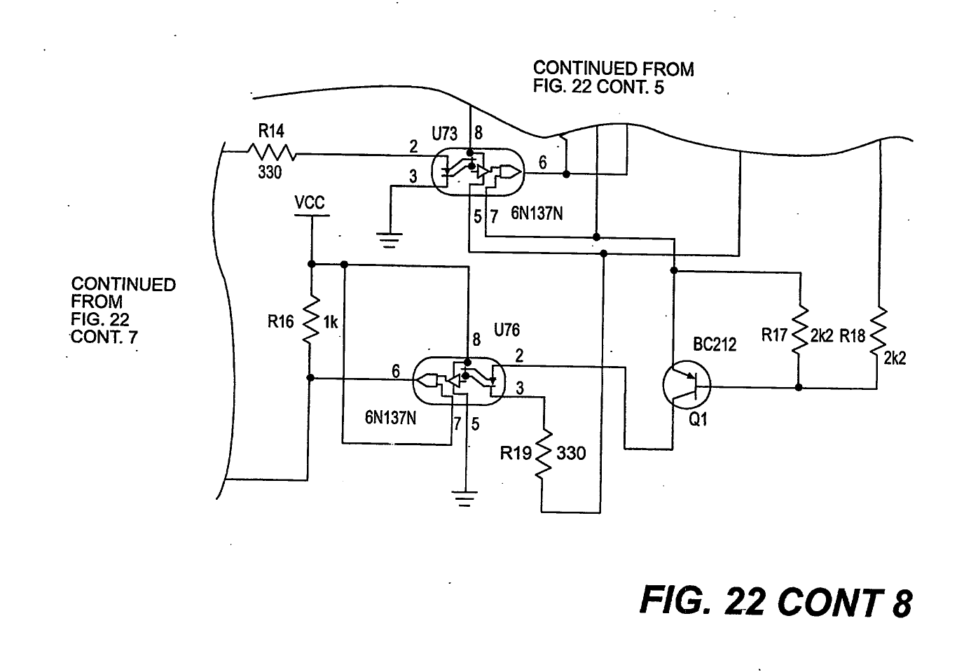

FIG. 21 shows a counter circuit that can be used in the present invention. The circuit consists of three cascades connected to a 14-bit asynchrony counter (32-bit counter). U1 enables and disables the counting in relation to a gate signal that comes from the programmable time base generator shown in FIG. 22. The outputs of counters are connected to a shift-register, which transforms the parallel data to serial. A frequency measurement starts when the gate signal goes to a high level. The counter counts the periods of the signal. When the gate level drops down (i.e. the counting time is over), the microcontroller reads out the count value from the counter and divides by the gate time (counting time) to provide the frequency. The 32-bit counter and time base gives accurate measurements.

FIG. 22 shows the microcontroller (U75). This integrated circuit is responsible for all functions of the system. It provides intelligent, hand-shaking serial communication between the instrument and the computer. It also controls all processes during the measurement. It is also responsible for temperature control. U69 is a time base generator that drives the programmable divider (U70) producing the gate signal. The microcontroller has its own sophisticated program that provides robust working conditions for both frequency measurement and temperature control. U71 handles the serial communication trough opto-isolators for safe, noise free operation.

The device of the present invention may include a calibration system, preferably a calibration system that complies with NIST standards. Calibration can be referenced to Standard Reference Material 2490 National Institute of Standards & Technology (polyisobutylene in 2,6,10,14-tetramethylpentadecane and executed at several viscosity points by utilizing various molecular weight Poly(dimethylsiloxane) fluids. Viscosity can be measured, for example, at 37° C., 45° C., 50° C. and 80° C. and corrected for uncertainty of calibration measurements. The data is correlated to NIST results using regression analysis.

Also, the device of the present invention can be tested, prior to each use, for crystal suitability, i.e. to ensure that the detector crystals have not become damaged, contaminated, or have exceeded their useful lifetime. Crystal suitability is preferably tested using a standardized ionic aqueous solution, for example an aqueous sodium chloride solution. Detector crystal quality can be verified by measurements taken on such a standard sodium chloride solution.

Another significant feature of the present invention is that the detector crystals can be cleaned to extend their useful life. The high temperature crystal cleaning process is accomplished by placing the crystals into a PyroPort™ crystal transport holder and positioned the crystal transport holder in a PyroStrip™ dual temperature mode (high temperature and Peltier) vacuum chamber. The temperature is programmed to 300° C., held for 30 minutes and the device is cooled. The vacuum pump is turned on and after the temperature falls below 40° C., the vacuum is reduced to permit opening of the cover. The PyroPort™ is removed and the crystals are checked for crystal suitability as discussed above using a 0.01N aqueous solution of sodium chloride. The crystal suitability requirement is met by verifying that frequency change difference for neat crystals versus crystals immersed in the aqueous sodium chloride solution is within a reference standard range.

The foregoing detailed description of the invention has been provided for the purpose of illustration and description only and is not to be construed as limiting the scope of the invention in any way.

1. A multi-channel acoustic measurement device which comprises:
a plurality of sample chambers,
a controller for controlling one or more conditions of said sample chambers,
a plurality of acoustic detectors, each said acoustic detector comprising a piezoelectric crystal and being located in one said sample chamber;
a driving device connected to said plurality of acoustic detectors for causing a perturbation of said acoustic detectors, and
a data device for obtaining data from said acoustic detectors.

2. A multi-channel acoustic measurement device as claimed in claim 1, wherein the controller controls at least the temperature of said sample chambers.

3. A multi-channel acoustic measurement device as claimed in claim 2, wherein the data device is selected from the group consisting of a data storage device, a data processing device and a combination of a data processing and storage device.

4. A multi-channel acoustic measurement device as claimed in claim 3, wherein said controller is programmable.

5. A multi-channel acoustic measurement device as claimed in claim 4, further comprising a multiplexer connected between said driving device and said acoustic detectors.

6. A multi-channel acoustic measurement device as claimed in claim 5, wherein said driving device is selected from the group consisting of an oscillator, a digital data sensitizer and a fourier transform frequency generator.

7. A multi-channel acoustic measurement device as claimed in claim 6, wherein said multiplexer is programmable.

8. A multi-channel acoustic measurement device as claimed in claim 7, further comprising a data validator.

9. A multi-channel acoustic measurement device as claimed in claim 1, further comprising a programmable multiplexer connected between said driving device and said acoustic detectors.

10. A method for obtaining data from a plurality of samples comprising the steps of:
providing a plurality of sample chambers containing samples,
providing a plurality of acoustic detectors, each said acoustic detector comprising a piezoelectric crystal and being located in one said sample chamber;
driving each said piezoelectric crystal to a resonant frequency, and
measuring at least one property of a plurality of said acoustic detectors.

11. A method as claimed in claim 10, wherein said sample chambers are configured as 96 well plate geometry, and in said providing step, 96 sample chambers are provided.

12. A method as claimed in claim 10, wherein said driving step is carried out according to a pre-programmed control program.

13. A method as claimed in claim 12, further comprising the step of controlling the temperature of said sample chambers.

14. A method as claimed in claim 13, wherein said temperature control step is carried out according to a pre-programmed control program.

15. A method as claimed in claim 14, further comprising the step of processing at least one measurement obtained in said measuring steps.

16. A method as claimed in claim 15, wherein said method provides a measurement selected from the group consisting of a resonant frequency measurement, a amplitude measurement, a phase feedback measurement, a direct decay measurement and a phase frequency spectrum measurement.

17. A method as claimed in claim 16, wherein said method provides information about one or more properties of the acoustic detector selected from the group consisting of resonant frequency change, the rise of the resonant frequency change, onset resonant frequency change, dissipation, the dissipation change, complex impedance, phase change, change in signal amplitude, Q-factor and any combination thereof.

18. A method as claimed in claim 17, wherein said method provides information about the sample selected from the group consisting of mass, visco-elasticity, glass transition temperature, binding factor, biosensor specific concentration, particle size, kinetic cascade patterns, presence of a specific material in the sample and combinations thereof.

19. A method as claimed in claim 18, wherein said processing step comprises processing one or more measurements to adjust for temperature dependence of said one or more measurements.

20. A method as claimed in claim 10, wherein said piezoelectric crystals comprise crystals selected from the group consisting of quartz crystals and gallium phosphide crystals.

21. A method as claimed in claim 20, wherein said driving step comprises oscillating said piezoelectric crystals using a multiplexed output from an oscillator circuit.
